(19) United States
(12) Patent Application Publication
(10) Pub. No.: US 2006/0282680 A1
(43) Pub. Date: Dec. 14, 2006

(54) Method and apparatus for accessing digital data using biometric information

(76) Inventors: Douglas A. Kuhlman, Inverness, IL (US); Ezzat A. Dabbish, Cary, IL (US); Thomas S. Messerges, Schaumburg, IL (US); Dean H. Vogler, Algonquin, IL (US)

Correspondence Address: MOTOROLA, INC., 1303 EAST ALGONQUIN ROAD, IL01/3RD, SCHAUMBURG, IL, 60196, US

(21) Appl. No.: 11/152,607

(22) Filed: Jun. 14, 2005

(51) Int. Cl. H04K 1/00

(52) U.S. Cl. 713/186

(57) ABSTRACT

A method and system for registering a user device in a domain of a domain authority (106) using biometric information is provided. The method includes sending (402) a request (by the user device) to the domain authority for joining the domain. The user device making the request is then authenticated (400) and the biometric information of the user is then requested (406). Further, the method includes authenticating (412) the biometric information of the user. The security information of the domain is transferred (414) to the user device once the authentication of the user device and the biometric information are both successful.

### RELATED APPLICATION

This application is related to the following application: Co-pending U.S. patent application Ser. No. 09/942,010, entitled ‘System and Method for Secure and Convenient Management of Digital Electronic Content’, filed on Aug. 29, 2001, and published as US 2002-0157002 A1.

### FIELD OF THE INVENTION

This invention relates in general to communication systems, and more specifically to a method and system for registering a user device using biometric information.

### BACKGROUND OF THE INVENTION

Electronic devices are widely used for accessing and sharing digital data for entertainment, education, and other purposes. Electronic devices access and share digital data such as music, video, software, books, and games, through means such as the Internet or other communication networks. The advent of powerful mobile computing and wireless devices, and their increased interconnectivity, has led to a manifold growth in the access to digital data.

However, an increase in the popularity and availability of the digital data has raised concerns over its illegal copying and distribution. The illegal copying, or piracy, of digital data drastically reduces or eliminates potential business opportunities related to the digital data. In order to avoid the piracy that is prevalent using the Internet, owners of the digital data are relying on secure content management mechanisms, for example, digital rights management (DRM) technologies.

DRM involves the protection of rights and management of rules related to accessing and processing of digital data. DRM technologies enable authorized access to digital data, and may also include the ability to copy the digital data under certain circumstances. Moreover, DRM technologies also prohibit unauthorized use of the digital data, such as sending it by email and/or publishing it on the World Wide Web.

A known method for DRM restricts the rendering of digital content to a single device or a group of devices. For example, a user can purchase content for the exclusive use on a device or group (i.e., domain) of devices. In such a system, rules stipulate to which devices the content is bound. Typically, content bound to a device or domain cannot be rendered or otherwise copied outside of this device or domain of devices, without restrictions. A DRM management kernel on each device and an infrastructure-based system enforce the content usage and device enrollment policies.

Domain-based DRM systems enable a user to add or remove devices from a domain, but can burden the user with cumbersome enrollment methods. For example, a user may enroll commonly-used devices into a domain. At a minimum, the enrollment procedure may require a user to identify the domain (e.g., by ID or name) and for security purposes, a password or personal identification number. However, the burden of requiring an enrollment procedure makes it difficult for a user to seamlessly gain access to the content on a device outside of the preconfigured domain. Users generally do not like the extra steps and precautions necessary to add security measures. Thus, there is a need for approaches that enable a user to more easily manage a DRM system and gain access to their content, not only on a preconfigured domain of devices, but on any device that they desire.

### BRIEF DESCRIPTION OF THE DRAWINGS

Various embodiments of the invention will hereinafter be described in conjunction with the appended drawings provided to illustrate and not to limit the invention, wherein like designations denote like elements, and in which:

FIG. 1 is a block diagram of an exemplary environment, in accordance with some embodiments of the present invention.

FIG. 2 is a block diagram of the subcomponents of a domain authority, in accordance with some embodiments of the present invention.

FIG. 3 is a block diagram of the subcomponents of a user device, in accordance with some embodiments of the present invention.

FIG. 4 and FIG. 5 illustrate a flowchart for registering a device in a domain of a domain authority, in accordance with some embodiments of the present invention.

FIG. 6 is a block diagram that shows a user device using a device already registered in a domain to capture and send the biometric information to the domain authority, in accordance with some embodiments of the present invention.

FIG. 7, FIG. 8, and FIG. 9 illustrate a flowchart for managing access to digital data, in accordance with some embodiments of the present invention.

FIG. 10 is a block diagram of a user device enabling access to the digital data, in accordance with some embodiments of the present invention.

FIG. 11 is a block diagram of a domain authority for managing domains, in accordance with some embodiments of the present invention.

### DETAILED DESCRIPTION OF THE INVENTION

Before describing in detail a method and system for registering a user device in a domain of a domain authority using biometric information, in accordance with the present invention, it should be observed that the present invention resides primarily in combinations of method steps and system components related to accessing of digital data. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

The present invention relates to a method and system for registering a user device in a domain of a domain authority, using biometric information of the user of the user device. The user device is registered in the domain to enable the user device to access the digital data corresponding to the user. Examples of digital data include music and video files, software and games. A domain may be defined as, but is not limited to, a set of trusted devices that share a common domain key that allows content designated for the domain to be accessed from any device in the domain. Further details about the type of domain and domain authority described herein are provided by United States patent publication no. US 2002-0157002 A1, titled “System and Method for Secure and Convenient Management of Digital Electronic Content”.

In various embodiments of the invention, the biometric information that is used for registering a user device in the domain of the domain authority may include but is not limited to fingerprints, voice patterns, eye retinas, irises, facial patterns or hand measurements.

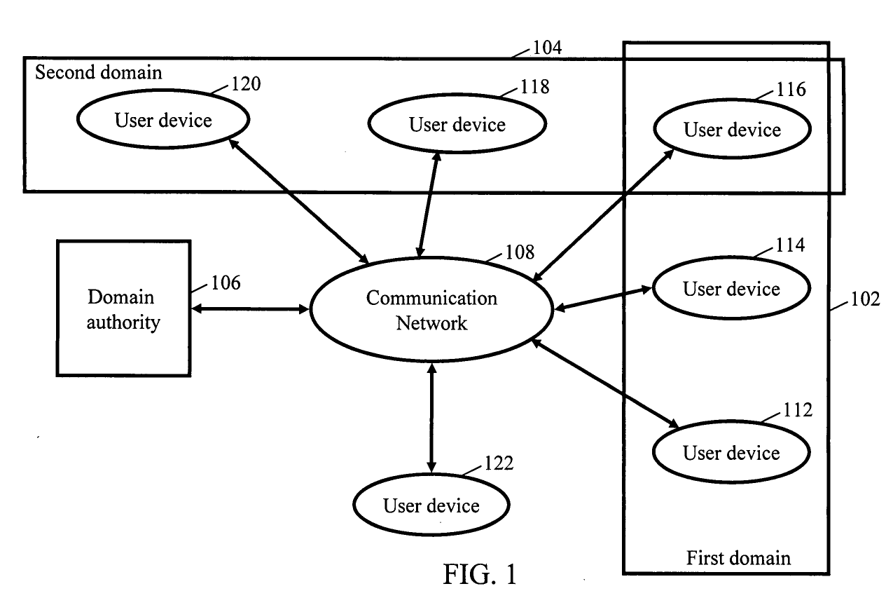

Referring to FIG. 1, a block diagram depicts an exemplary environment, in accordance with some embodiments of the present invention. The exemplary environment of the present invention includes a first domain 102, a second domain 104, a domain authority 106, a communication network 108, and user devices. A user device is an electronic device used by a user to access and/or manipulate digital data which the user may have rights to use. The first domain 102 has a user device 112, a user device 114 and a user device 116, registered in it. Similarly, the second domain 104 has the user device 116, a user device 118 and a user device 120, registered in it. A user device 122 is not registered either to the first domain 102, or to the second domain 104. In a typical environment, there may be many domains such as 102 and 104, each with their own devices. Also in a typical environment there will be many devices such as user devices 112, 114, 116, 118, 120, and 122, each registered to zero or more domains.

A user device is granted access to the digital data of a domain once it is registered in that domain (e.g., the user device is given the domain key). The user device is registered and/or un-registered in a domain by the domain authority 106. For example, the user device 112 is registered in the first domain 102 by the domain authority 106. The communication network 108 provides communication channels or links between user devices and the domain authority 106. For example, the communication network 108 provides communication between the user device 112 and the domain authority 106. In various embodiments of the invention, the communication network 108 may be a wired or a wireless medium. In an embodiment of the invention, the communication may be established using a secure, authenticated channel. Examples of the communication network 108 include, but are not limited to, a cellular network, the Internet, a local area network, and the like. Examples of the user device 112 include, but are not limited to, a wireless communication device, a 3G mobile phone, a car or home stereo, a set-top box, a Personal Digital Assistant (PDA), a personal computer, and the like. In an embodiment of the invention, a user may request that the domain authority 106 register one or more devices in one or more domains. The registrations might occur simultaneously or over a period of time. For example, in FIG. 1 the user device 116 is registered in both the first domain 102 and the second domain 104. In such a situation, the first domain 102 and the second domain 104 are said to be overlapping domains.

The domain authority 106 registers a user device in a domain by providing the user device with security information corresponding to the domain. In an embodiment of the invention, security information comprises a domain key. Further, the content in a DRM system is encrypted with a content key. When content is delivered to a device in a domain (e.g., by a content provider not shown in this invention), the content key may be encrypted with the domain key of the target domain (e.g., first domain 102). A user device registered to the target domain may use the domain key to decrypt the encrypted content key to recover the content key, which can then be used to decrypt and recover the digital data (i.e., the content). Only devices in the target domain have access to the domain key needed to decrypt the content key. Thus, only devices registered in the domain that have received the domain key from the domain authority 106 can access the digital content. In one embodiment of the present invention, key decryption (i.e., unwrapping) can be accomplished using traditional symmetric-key or public-key cryptography. For example, the Advanced Encryption Standard (i.e., AES), elliptic-curve cryptography, or RSA cryptography may be used. One aspect of the security of a domain-based DRM system relies on a user device being trusted by the domain authority 106 to maintain the secrecy of the domain key. In one embodiment, prior to operating in the DRM system, each user device is embedded with unique serial numbers and cryptographic elements such as one or more private keys and public-key certificates. A public-key or symmetric-key infrastructure exists to try to ensure that only trusted user devices are given the proper serial numbers and cryptographic elements to operate in the DRM system. The domain authority 106 uses these serial numbers and cryptographic elements (e.g., via public-key or symmetric-key authentication schemes) to ensure that only authentic user devices become members of a domain. The domain authority 106 maintains or has access to a revocation list of compromised devices and domains which it uses to prevent registration of an un-authorized user device. The domain authority 106 may also un-register a user device from a domain by sending the user device a command to remove the domain key. The domain authority 106 is further responsible for managing the user devices in a domain. In an embodiment of the invention, the limit to the number of devices registered in a domain is predefined. It should be readily apparent to one of normal skill in the art that this process can be repeated for multiple domain authorities, so that a single user could be registered with one or more domains at one or more domain authorities. Standard methods would allow for a broker of domain authorities or for simply repeated operations at each domain authority.

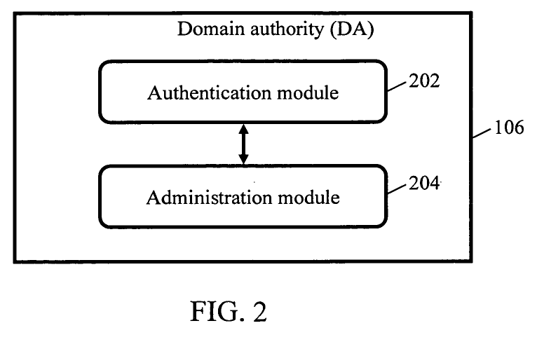

Referring to FIG. 2, a block diagram illustrates some subcomponents of the domain authority 106, in accordance with some embodiments of the present invention. The domain authority 106 includes an authentication module 202 and an administration module 204. The authentication module 202 performs two main functions. First, the authentication module 202 checks the authenticity of each user device requesting registration into a domain. In one embodiment, the user device 122 is provisioned with a private key and a corresponding certificate containing the public key. The domain authority 106 creates a random challenge and sends it to the user device 122. The user device 122 uses the private key to sign the random challenge. The signature is returned to the domain authority 106, which uses the public key information from the certificate to verify its authenticity. Second, the authentication module 202 uses a template of stored biometric information of authorized users to process the biometric information corresponding to the current user of the user device 122. Examples of the biometric information include, but are not limited to, a fingerprint, a voice sample, a facial picture, and the like. In one embodiment, the user device sends raw biometric information and the authentication module 202 uses known methods of determining features of the received biometric information. In an alternate embodiment, the user device determines the features of the biometric information and sends the features to the authentication module 202. In either case, the features from the received biometric information are compared to the stored biometrics template at the domain authority 106. In the case that the domain-enrollment request from the user device 122 identifies a domain by name or an identification number, the authentication module 202 compares the features of the received biometric information to the features expected for the identified domain (e.g., first domain 102). Otherwise the authentication module 202 uses the features of the received biometric information to determine the respective domain's identity. Upon successful biometric processing (e.g., the comparison succeeds or a match is found), the authentication module 202 requests the administration module 204 to register the user device 122 in the identified domain (e.g., first domain 102). The administration module 204 then sends the security information of the domain corresponding to the identified domain (e.g., the domain key for that domain) to the user device 122. This registers the user device 122 in the domain. In various embodiments of the invention, the domain authority 106 may include other subcomponents performing alternative functions, such as those described by United States patent publication no. US 2002-0157002 A1, titled “System and Method for Secure and Convenient Management of Digital Electronic Content”.

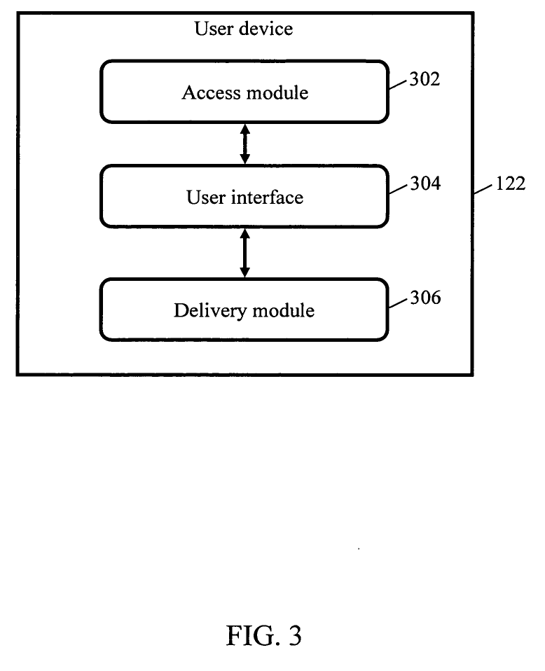

Referring to FIG. 3, a block diagram depicts some subcomponents of the user device 122, in accordance with some embodiments of the present invention. The user device 122 includes an access module 302, a user interface 304, and a delivery module 306. The access module 302 accepts a user request for accessing digital data (i.e., content), which has been assigned to a particular domain. If the user device 122 is not already a member of this domain (e.g., the user device is a device that the user has never encountered—such as a radio in a rental car or a newly purchased device), this user request causes access module 302 to send a domain-enrollment request (on behalf of a user) to the domain authority (for example, domain authority 106). This domain-enrollment request starts the process of registering the user device 122 into the user's domain (as described in FIG. 2). For example, this domain-enrollment request may identify a domain by name or identification number, such as a name identifying the first domain 102 or may otherwise state that the user device is requesting access to a domain with no particular information about a domain. Upon receiving this request to add user device 122 to a domain, the domain authority 106 sends a request for the user's identity information back to the user device 122. The user interface 304, on receiving the request for the user's identity information from the domain authority 106, captures the biometric information corresponding to the user of the user device 122. Examples of biometric information capturing instruments that can be used by user interface 304 include, but are not limited to, a camera, a fingerprint scanner, a microphone, and the like. The delivery module 306 delivers the biometric information of the user to the domain authority 106 for authentication. The delivery module 306 alternatively may also extract features corresponding to the biometric information and transfer these features to the domain authority 106.

The access module 302 is also responsible for proving the authenticity of the user device 122 to the domain authority 106. This is typically performed by signing a random challenge and providing a signed certificate with information about the user device to the domain authority 106. The authenticity can also be proved by a dedicated module in the user device like a Trusted Platform Module (TPM). Defined originally by the Trusted Computing Platform Alliance and later refined by the Trusted Computing Group, the TPM is a hardware module that performs some trusted processing such as signing with private keys, generating random numbers, and protecting some limited information on the user device 122. In various embodiments of the invention, the subcomponents of the user device 114, the user device 116, the user device 118, the user device 120, and the user device 112 are similar to or the same as those of the user device 122.

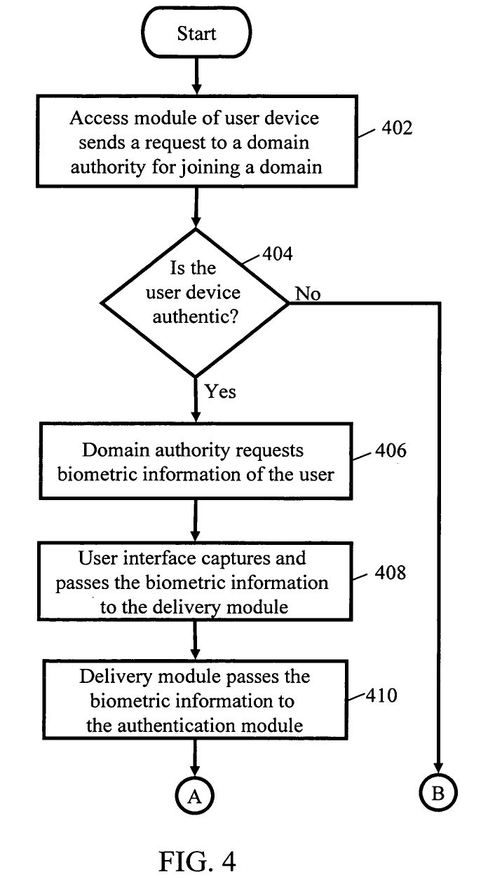

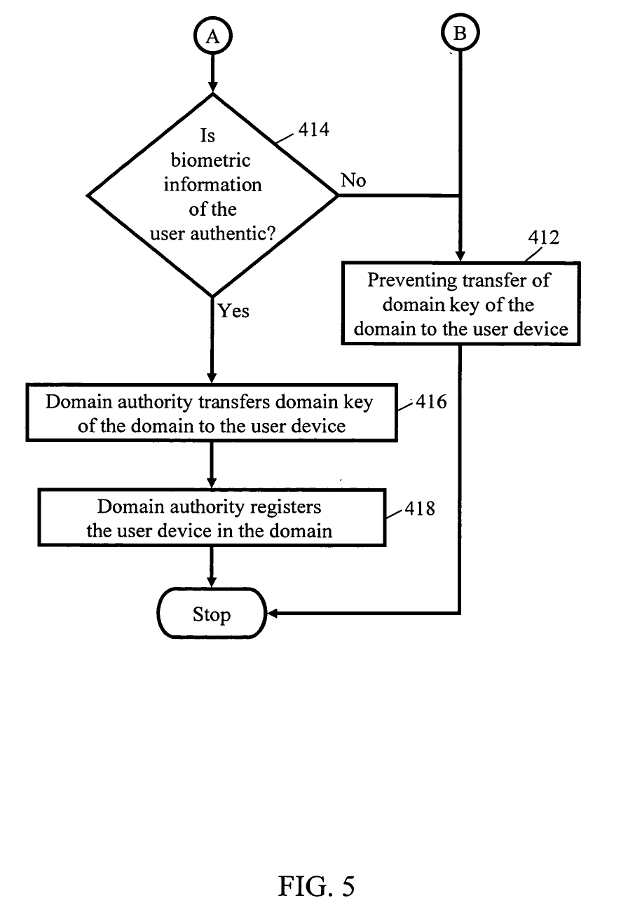

Referring to FIG. 4 and FIG. 5, a flowchart shows some steps of a method for registering the user device 122 in the first domain 102 of the domain authority 106, in accordance with some embodiments of the present invention. At step 402, the access module 302 of the user device 122 sends a request (on behalf of a user) for registering in the first domain 102 of the domain authority 106. On receiving the request for registration of the user device 122, the authentication module 202 validates the authenticity of the user device 122, at step 404. If the user device 122 is found authentic, step 406 is performed. At step 406, the domain authority 106 sends a request to the user device 122 for identifying the biometric information of the user. At step 408, the user device 122 authenticates the domain authority's request and, if authentic, user interface 304 captures the biometric information corresponding to the user of the user device 122 and passes the biometric information to the delivery module 306. At step 410, the delivery module 306 passes the biometric information to the authentication module 202. One skilled in the art will realize that the passed biometric information might be the full record of the biometric or extracted features obtained by partially processing the biometric. In various embodiments of the invention, the biometric information is passed using a secure authenticated channel. If the user device 122 is not found to be authentic, step 412 (in FIG. 5) is performed. At step 412, transfer of a domain key to the user device 122 is prevented. At step 414 (in FIG. 5), the authentication module 202 processes the biometric information of the user. Alternatively, the features may be processed. If processing succeeds, (i.e., the biometric information of the user is found authentic or uniquely identifies a domain corresponding to that user), step 416 (in FIG. 5) is performed. If the biometric information corresponds to more than one domain, then the user is given the option of selecting a desired domain in which to enroll the user device. In an alternate embodiment, the user device is enrolled into all domains which were determined to correspond to the user. At step 416, the administration module 204 transfers the domain key (or multiple domain keys, in the case it is enrolling a user device into more than one domain) to the user device 122. As a result, the user device 122 is registered in the domain (or domains). At step 418 (in FIG. 5), the administration module 204 records the registration of the user device 122 in the first domain 102 of the domain authority 106. If the processing of the biometric information of the user fails (i.e., the biometric information is not found authentic or it does not identify any domain), step 412 is performed. At step 412, transfer of domain key to the user device 122 does not take place. Hence, the user device 122 is registered on the first domain 102 only if both the user device 122 is found to be authentic and the processing of the user's biometric information is successful.

In an embodiment of the present invention, biometric information sent from or to the domain authority 106 may be in the form of the actual biometric (e.g., a fingerprint image, a voice print) or features extracted from the actual biometric (e.g., fingerprint minutiae). For example, the domain authority 106 may simply store the biometric features and the user device 122 may extract and send these features rather than the actual biometric information.

In alternative embodiments of the invention, the authorization of the biometric information of the user may be performed by the user device 122. The user device 122 may verify the biometric information corresponding to the user, by comparing the biometric information to a pre-registered (local) biometric information of the user, in the user device 122. The method the user device 122 uses to authenticate the biometric information is similar in scope to the one that would be used by the domain authority 106. The user device 122 would then make an authentication assertion regarding the authenticity of the user of user device 122 to the domain authority 106 using a method like the Security Assertion Markup Language (SAML) standardized by OASIS (Organization for the Advancement of Structured Information Standards).

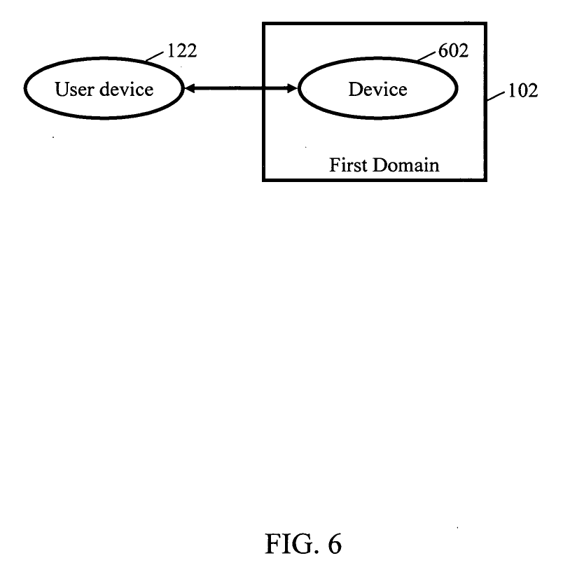

Referring to FIG. 6, a block diagram shows an embodiment of the invention in which a user device may use a device already registered in a domain to capture and send the biometric information to the domain authority 106. In various embodiments, the user device being registered (e.g., user device 122) need not have capabilities for capturing biometric information. For example, the device 602 already registered to first domain 102 may capture the biometric input, determine the user's identity and then securely send verifiable user identity information to the user device 122. The user device 122 securely forwards this verifiable user identity information to the domain authority 106 (e.g., using a secure and authenticated channel) either using its own communication capabilities or using device 602 as a communication proxy. The domain authority 106 verifies the received user identity information and proceeds according to FIG. 4. However, in this case, steps 406, 408, and 410 are replaced by steps where the user device 122, on receiving the biometric information from the device 602, forwards the verifiable user biometric information to the domain authority 106. Then, at step 414, the domain authority 106 verifies whether the received user identity information is authentic. If authentic, step 416 is performed, otherwise step 412 is performed. With this embodiment, a user can register a new device into a domain, by having a device already registered in the domain vouch for the user's identity (e.g., by capturing the user's biometric information). Further, the verifiable information being sent from the device already registered in the domain need not contain actual biometric information (e.g., it can be an authentication assertion represented using SAML), thus avoiding a need for the domain authority 106 to store a user's biometric information.

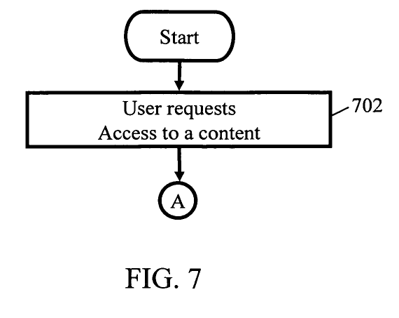

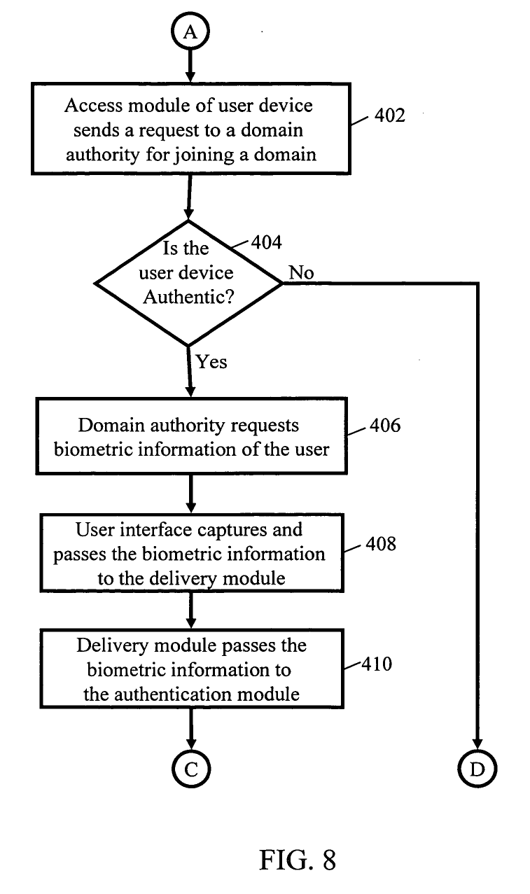

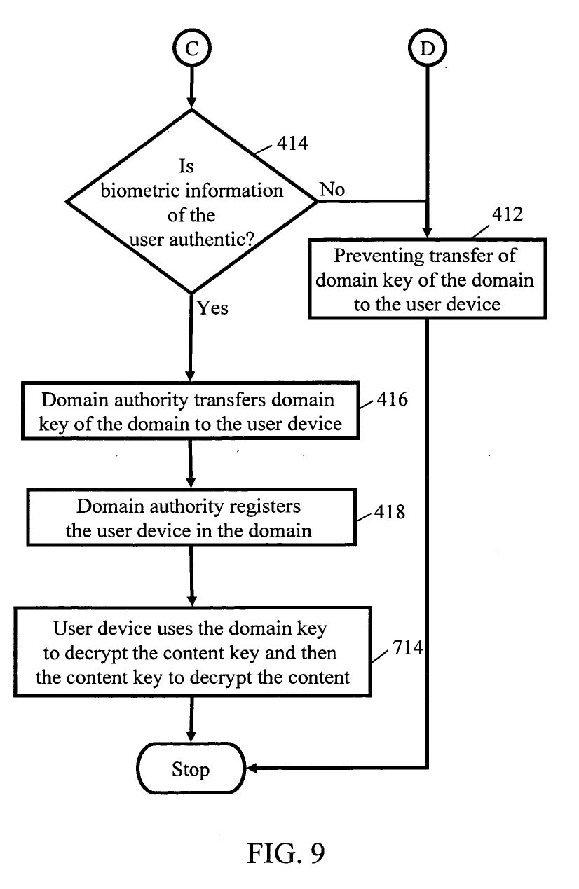

Referring to FIG. 7, FIG. 8, and FIG. 9, a flowchart shows some steps of a method for managing access to digital data, in accordance with some embodiments of the present invention. In FIG. 7 at step 702, the user requests access to a content on user device 122. If the user device 122 is not registered in a domain, the steps 402 to 418 (shown in FIG. 8 to FIG. 9 and as described with reference to FIG. 4 and FIG. 5) are performed to register the user device 122 in a domain of the domain authority 106. Once the user device 122 is registered in the domain of the domain authority 106, step 714 (in FIG. 9) is performed. At step 714, the user device 122 uses the domain key to decrypt the encrypted content key to recover the content key. The content key is then used to decrypt the digital data. Hence, the domain authority 106 provides access to the digital data to the user.

In an embodiment of the invention, the user device 122 will belong to the first domain 102 for a pre-defined period of time. After this predefined period, the domain authority 106 will further require authentication information from the user, for example, reacquisition of biometric information, information that indicates continued usage, and the like. If the authentication information is not received, the user device 122 will automatically be un-registered from the first domain 102.

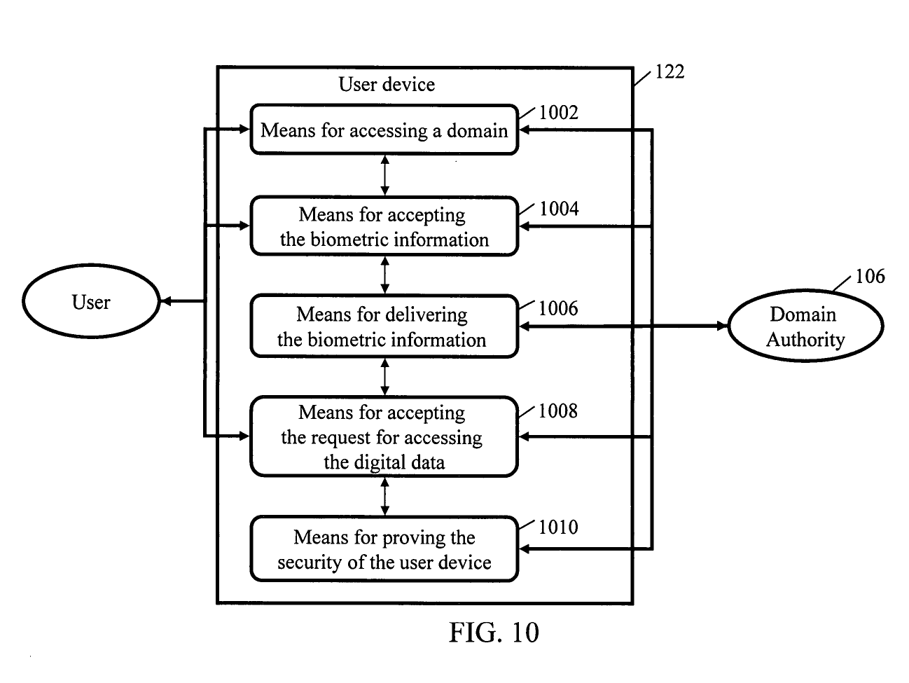

Referring to FIG. 10, a block diagram shows the user device 122 for enabling access to the digital data, in accordance with some embodiments of the present invention. The user device 122 comprises a means for accessing a domain 1002, a means for accepting the biometric information 1004, a means for delivering the biometric information 1006, a means for accepting the request for accessing the digital data 1008, and a means for proving the security of the user device 1010. The means for accessing a domain 1002 initiates a request for registering the user device 122 to the first domain 102 of the domain authority 106. The means for accepting the biometric information 1004 accepts the biometric information from the user. In some embodiments, the means for accepting the biometric information may do some initial processing (e.g. feature extraction) on the biometric information from the user. It is understood that biometric information may mean either the raw biometric or the processed result. The means for delivering the biometric information 1006 transfers the biometric information for authentication. The biometric information is used to register the user device 122 in the first domain 102 of the domain authority 106. The means for accepting the request for accessing the digital data 1008 accepts the request from the user. The means for proving the security of the user device 1010 gives cryptographic and security reasons to the domain authority 106 to ensure that the user device 122 has the necessary security precautions to be allowed entry into a domain.

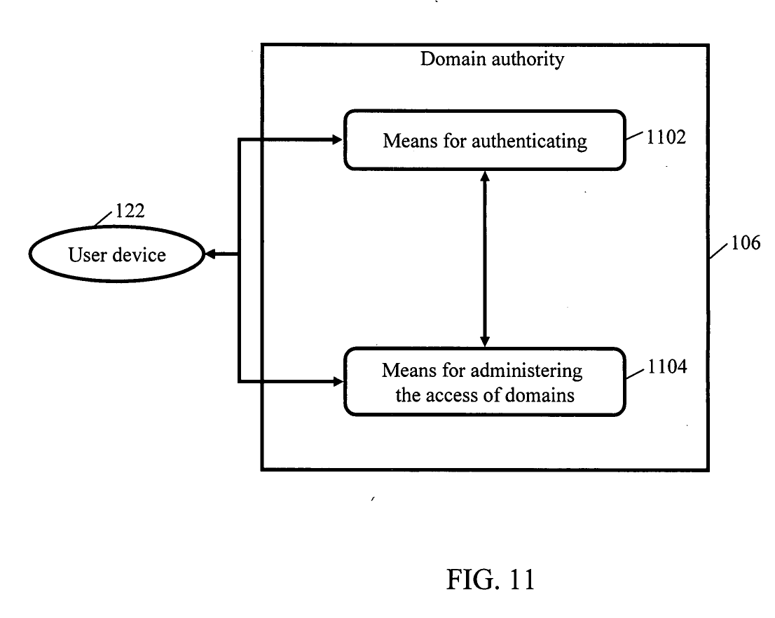

Referring to FIG. 11, a block diagram shows the domain authority 106 for managing domains, in accordance with some embodiments of the present invention. The domain authority 106 comprises a means for authenticating 1102 and a means for administering the access of domains 1104. The means for authenticating 1102 verifies the authenticity of the one or more user devices. The means for authenticating 1102 further verifies the biometric information sent by the means for delivering the biometric information 1006. The means for administering the access of domains 1104 registers the one or more user devices in a domain. The one or more user devices are registered only when the one or more user devices, and the biometric information of the user of the one or more user devices, are authenticated.

It will be appreciated that the method of accessing digital data described herein may be comprised of one or more conventional processors and unique stored program instructions that control the one or more processors to implement some, most, or all of the functions described herein; as such, the functions of authenticating the user device and requesting biometric information may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

1. A method for registering a first user device in a domain of a domain authority, the first user device being used by a user for accessing digital data of the domain, the method comprising:
sending a request to join the domain, wherein the request is sent by the first user device to the domain authority;
submitting authentication information of the first user device making the request;
requesting biometric information of the user;
authenticating the biometric information of the user; and
receiving security information of the domain by the first user device, wherein the security information has been transmitted in response to successful authentication of both the first user device and the biometric information

2. The method according to claim 1, wherein the request for the biometric information is sent by the domain authority to the first user device.

3. The method according to claim 2, wherein the request for the biometric information is authenticated by the first user device.

4. The method according to claim 1, wherein the authentication of the biometric information of the user is performed by the first user device.

5. The method according to claim 1, wherein the authentication of the biometric information of the user is performed by the domain authority.

6. The method according to claim 1, wherein the request for the biometric information is processed by a second user device.

7. The method according to claim 6, wherein the processing by the second user device comprises capturing and authenticating the biometric information of the user.

8. The method according to claim 6, wherein the processing by the second user device comprises capturing the biometric information of the user and sending it to the domain authority.

9. The method according to claim 1, wherein the security information of the domain is not transmitted when the authentication of at least one of the first user device and the biometric information is unsuccessful.

10. The method according to claim 1, wherein the security information of the domain comprises a domain key.

11. The method according to claim 1 further comprising the first user device accessing digital data.

12. The method according to claim 11, wherein the digital data is stored in a communication network in a protected form such that the digital data is only accessible by using the security information of the domain.

13. The method according to claim 12, wherein the digital data is encrypted with a content key.

14. The method according to claim 12, wherein the security information comprises an encrypted content key and a domain key, the domain key being used to decrypt the encrypted content key, which recovers the content key.

15. The method according to claim 1 further comprising:
sending an additional request for verifying the biometric information from the domain authority to the user device; and
un-registering the first user device from the domain authority, wherein the first user device is un-registered from the domain authority when no valid response to the additional request is received at the domain authority from the user or the user device after a time interval.

16. A domain authority for registering one or more user devices in a domain of the domain authority, the user device being registered in the domain to access digital data, the domain authority comprising:
means for authenticating the one or more user devices, the authentication module further verifying the biometric information; and
means for administering that registers the one or more user devices in the domain, wherein each of the one or more user devices is registered only when the user device sending the request for accessing the digital data has been authenticated and the biometric information corresponding to the user has been authenticated.

17. The domain authority according to claim 16, wherein the means for administering registers the one or more user devices in the domain by sending a domain key.

18. A user device for accessing digital data corresponding to one or more domains of one or more domain authorities, the user device comprising:
an access means for sending a request for registering the user device corresponding to the access module and for proving the authenticity of the user device to a domain authority;
a user interface means for accepting biometric information from a user, the biometric information being used for registering the user device in the domain authority; and
a delivery means for delivering the biometric information for authentication,
wherein, in response to the authentication of the biometric information by the domain authority, the user device is registered in the one or more domains, to enable access to the digital data.

19. The user device according to claim 18, wherein the access means receives a domain key from the domain authority, the domain key registering the user device in the domain.

20. The user device according to claim 18, wherein the user device is a wireless communication device.
